(19) United States
(12) Patent Application Publication
(10) Pub. No.: US 2010/0021860 A1
(43) Pub. Date: Jan. 28, 2010

(54) Ergonomic high volme evacuator system

(76) Inventors: Stephanie Christman, Spokane, WA (US); Terry L. Fitzthum, Spokane, WA (US)

Correspondence Address: BERGMAN & JECKLE P.L.L.C., 421 W. RIVERSIDE, SUITE 717, SPOKANE, WA, 99201, US

(21) Appl. No.: 12/220,668

(22) Filed: Jul. 28, 2008

(51) Int. Cl. A61C 17/06

(52) U.S. Cl. 433/96

(57) ABSTRACT

An ergonomic high volume evacuator system provides a tapered tubular evacuator tool having a body defining a medial channel with an angulated mirrored guard having an optically reflective insert adjacent a beveled input orifice. A flexible evacuation hose having an integral coil spring and a vacuum connector pneumatically releasably interconnect the evacuator tool with a vacuum source. An axially rotatable evacuator tool connector provides a releasable pneumatic and fluidic sealed interconnection between the evacuator tool and the evacuation hose.

### RELATED APPLICATIONS

There are no applications related hereto heretofore filed in this or in any foreign country.

### BACKGROUND OF INVENTION

1. Field of Invention

This invention relates to dentistry, and more particularly to an ergonomic dental tool system having means to facilitate viewing of ongoing dental procedures and a suction orifice to evacuate dental debris from a patient's mouth.

2. Background and Description of Prior Art

A dentist, a dental hygienist or other dental professional, hereinafter collectively referred to as “dentist”, performing a dental procedure needs to perform three functions. The dentist must complete the necessary work, such as cleaning teeth, preparing a tooth for repair or repairing a tooth; the dentist must be able to visualize the procedure while it is being performed, in particular the operative end of the dental instrument which may be sharp, hooked or rotating; and the dentist must evacuate dental debris from the patient's mouth to prevent the patient from gagging or choking.

Dental work frequently entails use of an ultrasonic tool that employs high frequency vibrations to clean teeth and high speed drills to prepare tooth surfaces for repair, such as a filling or a cap. Ultrasonic tools and drills are cooled with pressurized water that is ejected from an orifice proximate the tool tip to reduce heat build up and to wash debris away from the surface being worked upon. In addition to ultrasonic tools and drills, dentist frequently use sharp pointed and hooked instruments to scrape tarter and other deposits from patient's teeth. Because such dental tools and instruments have the capacity to quickly cause serious injury to a patient, it is imperative that the dentist continuously visualize the tool and instrument, its location and the surface being worked upon including the progress of the work. Commonly a mirror angularly carried at the end of an elongate handle is used to visually monitor the dental tool/instrument when the surface being worked upon is not oriented to the front of the patient's mouth.

Debris accumulate in the patient's mouth from secretion of saliva, coolant water from the dental tool, blood from mouth tissue, calcius scraped from tooth surfaces, tooth fragments from drilling, and various other causes and sources as the dental work progresses. Such debris need to be evacuated before the accumulation causes the patient to gag, cough and possibly vomit which could be deleterious for both the dentist and the patient.

Dental evacuators are used to remove the accumulation of debris from the patient's mouth during the course of the dental procedure and to help maintain patient comfort while allowing the dentist to safely continue working generally uninterrupted.

Holding and manipulating a sharp, hooked or perhaps rotating dental instrument, and a mirror and an evacuator simultaneously requires that a second dental professional be present throughout the dental procedure or that the dental procedure have a “stop and go” nature where dental work is performed for a period of time until the accumulated debris must be evacuated to prevent a deleterious event. Various devices that combine an evacuator tool and a visualization tool are known and are sometimes used as an alternative to requiring a second dental professional, and as an alternative to a “stop and go” type procedure.

However, known devices that combine an evacuator tool and a visualization tool have various drawbacks. Such devices are known to “grab” onto a patient's soft oral tissue causing the patient discomfort or to unexpectedly jump which may result in an injury. Such devices are also heavy, cumbersome and are not sufficiently manipulable to be user friendly. Although some evacuator tools may be constructed of lightweight materials, interconnecting a lightweight evacuator tool to a heavy and somewhat inflexible vacuum hose causes the tool and entire apparatus to become difficult to manipulate, user unfriendly and fatiguing for the user's hand and wrist. Such fatiguing stresses applied to a user's hand and wrist has been shown to be a cause of Carpel Tunnel Syndrome leading to injuries, disabilities and worker's compensation claims.

What is needed is a high volume evacuator system that combines an evacuation tool with a visualization tool, is lightweight and manipulable, does not “grab” onto a patient's soft oral tissues does not fatigue the hands and wrist of the dentist, maintains a clean visualization surface, is easily sterilized, and allows the dentist to perform dental procedures without having to interrupt the procedure to evacuate dental debris from a patient's mouth.

Our invention overcomes various of the aforementioned drawbacks by providing an improved ergonomic high volume evacuator system that combines a light weight evacuator tool with a reflective insert for visualizing the dental instrument and the tooth surface being worked upon. The reflective insert is retained in a cavity defined in an angulated guard at the end of the evacuator tool so that soft oral tissue can be retracted without the evacuator tool “grabbing” the tissue and causing patient discomfort. The angulated guard directs vacuum air inflow across the reflective insert keeping the reflective insert generally clear of debris that might interfere with visualization of the dental instrument and the tooth surface being worked upon.

The evacuator tool releasably interconnects with a highly flexible evacuation hose that pneumatically and fluidically interconnects the evacuator tool with a vacuum source. The interconnection of the evacuator tool and evacuation hose is axially rotatable to enhance manipulability. The evacuation hose is formed of a lightweight flexible material such as silicone and has an integrally incorporated coil spring to remain self sustaining against vacuum. A vacuum connector provides a standardized interconnection with a known dental vacuum source and also provides a tool holder to retain the evacuator tool when not in use.

The evacuator tool, the connections and evacation hose are detachable from the vacuum source and autoclavable for sterilization.

Our invention does not reside in any single one of the identified features individually but rather in the synergistic combination of all of its structures, which give rise to the functions necessarily flowing therefrom as hereinafter claimed.

### SUMMARY

Our ergonomic high volume evacuator system generally provides a tubular evacuator tool having a body defining a medial channel with an angulated mirrored guard having an optically reflective insert adjacent a beveled input orifice. A flexible evacuation hose having an integral coil spring and a vacuum connector pneumatically releasably interconnect the evacuator tool with a vacuum source.

In providing such an system it is:

a principal object to provide an ergonomic high volume evacuator system for use by dental professionals.

a further object to provide such a system that is lightweight and manipulable to minimize user hand and wrist fatigue.

a further object to provide such a system having an evacuator tool with an angulated mirrored guard adjacent a beveled input orifice that may be used as a tissue retractor.

a further object to provide such a system that has a reflective insert in the angulated mirrored guard allowing a dentist to continuously visualize a dental instrument and the surface being worked upon.

a further object to provide such a system wherein vacuum airflow into input orifice minimizes accumulation of debris on the reflective insert.

a further object to provide such a system having an evacuator tool that does not “grab” soft oral tissue.

a further object to provide such a system having an evacuation hose that is simultaneously lightweight highly flexible and self-sustaining under vacuum.

a further object to provide such a system having an axially rotatable interconnection between the evacuator tool and the evacuation hose to enhance manipulability.

a further object to provide such a system having removable and replaceable evacuator tool tips.

a still further object to provide such a system that is usable with a commercially available dental vacuum.

Other and further objects of our invention will appear from the following specification and accompanying drawings which form a part hereof. In carrying out the objects of our invention it is to be understood that its structures and features are susceptible to change in design and arrangement with only one preferred and practical embodiment of the best known mode being illustrated in the accompanying drawings and specified as is required.

### BRIEF DESCRIPTIONS OF DRAWINGS

In the accompanying drawings which form a part hereof and wherein like numbers refer to similar parts throughout:

FIG. 1 is an isometric front and side view of our ergonomic high volume evacuator system interconnected to a vacuum source shown in dashed outline.

FIG. 2 is an enlarged partial cut-away isometric front and side view of the evacuator tool, evacuation hose and evacuator tool connector carried in a vacuum connector.

FIG. 3 is a partial cut-away orthographic side view of the evacuator tool, evacuator tool connector, evacuation hose and vacuum connector.

FIG. 4 is a partial cut-away orthographic front view of the evacuator tool, evacuator tool connector, evacuation hose and vacuum connector.

FIG. 5 is an enlarged partial cut-away isometric view of the evacuator tool.

FIG. 6 is a partial cutaway isometric front and side view similar to that of FIG. 2 showing an evacuator tool extension between the evacuator tool and the evacuator tool connector.

FIG. 7 is an enlarged partial cut-away isometric view of the axially rotatable interconnection of the evacuator tool connector.

FIG. 8 is an enlarged partial cut-away orthographic side view of the mirrored guard and beveled input orifice showing angle α, angle θ and angle γ.

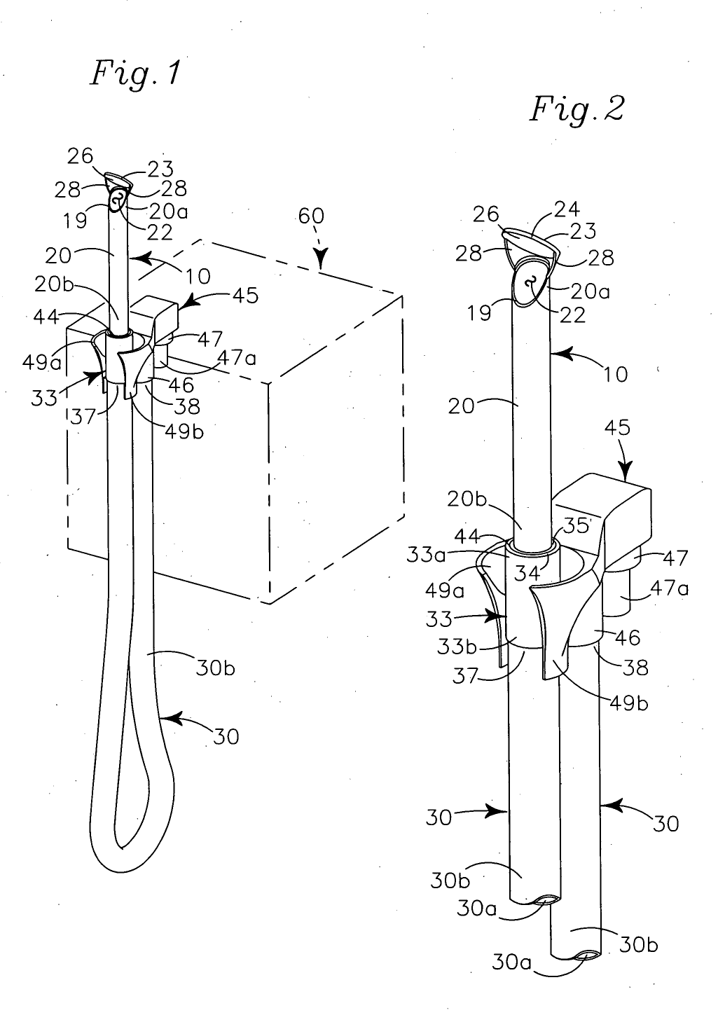

### DESCRIPTION OF PREFERRED EMBODIMENT

Our ergonomic high volume evacuator system provides evacuator tool 10, an evacuation hose 30 and a vacuum connector 45 operatively communicating with a vacuum source 60.

The evacuator tool 10 has a tapered tubular body 20 with a first end portion 20a, a diametrically larger second end portion 20b, and defines a medial channel 21 extending therethrough and therebetween. First end portion 20a defines input orifice 22 and carries angulated mirrored guard 23 immediately adjacent circumferential edge 19 of the input orifice 22. Circumferential edge 19 of the input orifice 22 is beveled toward the angulated mirrored guard 23 forming angle θ between axis 36 of the body 20 and the beveled input orifice 22. Angle θ is between approximately 25 degrees and approximately 50 degrees and is preferably approximately 30 degrees. (FIG. 8).

The mirrored guard 23 is generally disk shaped and angled relative to axis 36 of the body 20 at angle α between approximately 25 degrees and approximately 50 degrees. Angle α is preferably approximately 30 degrees. Angle γ between the bevel 19 of the input orifice 22 and the mirrored guard 23 is preferably approximately 120 degrees, but varies as angle α and angle θ change. (FIG. 8).

Guard flanges 28 interconnect circumferential edge 24 of the mirrored guard 23 and the body 20 adjacent input orifice 22 adding strength and rigidity to the mirrored guard 23 and to the interconnection therebetween. An optically reflective insert 26, such as a mirror, a disk of polished steel, piece of Mylar®, or similar reflective material is carried by mirrored guard 23 proximate the input orifice 22. The reflective insert 26 reflects light waves allowing the dentist to continuously visualize and monitor the dental instrument, the condition of the surface being worked upon and the progress of the dental procedure. In the preferred embodiment, the mirrored guard 23 defines a generally circular cavity 25 adjacent the input orifice 22 in which the reflective insert 26 is carried. Inner circumferential edge portions (not shown) of the cavity 25 extend radially inwardly to overlap outer circumferential edge portions (not shown) of the reflective insert 26 to positionally secure the reflective insert 26 within the cavity 25. Other known forms of attachment, such as adhesives, thermal boding, epoxies and the like may also be used to permanently secure the reflective insert 26 in the cavity 25 of the mirrored guard 23.

Angle α of the mirrored guard 23 relative to axis 36 of the body 20, the bevel 19 of the input orifice 22 and the guard flanges 28 operate in unison to concentrate airflow across and along the exposed surface of the reflective insert 26 minimizing accumulation of dental debris on the reflective insert 26 that might interfere with the visualization of the dental instrument and surface being worked upon. The airflow across the reflective insert 26 causes dental debris, which may be fluidic, solid or combinations thereof to be drawn across the surface of the reflective insert 26 and into the input orifice 22 for evacuation from the patient's mouth. A dentist may also spray water on the reflective insert 26 to wash accumulated debris therefrom. The water and “displaced” debris are similarly drawn into the input orifice 22.

Angle α of the mirrored guard 23 relative to axis 36, the guard flanges 28, and the bevel 19 of the input orifice 22 also allow the end portion of the evacuator tool 10 carrying the mirrored guard 23 to be used as a tissue retractor by the dentist during the dental procedure. The mirrored guard 23 and guard flanges prevent soft mouth tissue from being “grabbed” by the evacuator tool 10 due to the vacuum supplied by the interconnected vacuum source 60.

Second end portion of 20b of the body 20 defines output orifice (not shown) that communicates with the input orifice 22 via the medial channel 21. The second end portion 20b is releasably attachable to evacuator tool connector 33 in a male-female slip type connection.

The evacuator tool connector 33 is a rigid pipe like member having a first end portion 33a and an opposing second end portion 33b and provides an axially rotatable interconnection 44 between the evacuator tool 10 and the evacuation hose 30. As shown in FIG. 7, the evacuator tool connector 33 has an outer pipe-like member 34 defining an axial through channel (not shown) and an inner pipe-like member 35 that is axially carried within the axial channel (not shown) of the outer pipe-like member 34. The inner pipe-like member 35 is freely axially rotatable relative to the outer pipe-like member 34. A known seal (not shown) prevents pneumatic and fluidic leakage between inner circumferential surface (not shown) of the outer pipe-like member 34 and outer circumferential surface (not shown) of the inner pipe-like member 35. Inner pipe-like member 35 likewise defines an axial through channel (not shown).

The second end portion 20b of the evacuator tool 10 releasably slidably engages with the medial channel (not shown) of the inner pipe-like member 35 at the first end portion 33a in a fluid tight and pneumatic tight interconnection. The axially rotatable interconnection 44 improves the manipulability of the evacuator tool 10 relative to the evacuator tool connector 33 and the first end portion 37 of the evacuation hose 30, reduces user fatigue and promotes user friendliness.

Second end portion 33b of the evacuator tool connector 33 is fixedly connected with first end portion 37 of the evacuation hose 30 in a fluid tight and pneumatic tight interconnection.

Evacuation hose 30 has an inner circumferential surface 30a, an outer circumferential surface 30b and defines a medial channel 31 extending therethrough from first end portion 37 to second end portion 38. The evacuation hose 30 is preferably formed of a flexible thermally resistant silicone such as TC-5005 A/B from BJB Enterprises, Inc. although other thermally resistant flexible products with similar characteristics may also be used. A coil spring (not shown) is integrally incorporated into the evacuation hose 30 between the inner circumferential surface 30a and the outer circumferential surface 30b and extends between first end portion 37 and second end portion 38. The coil spring provides structural integrity to the evacuation hose 30 and prevents the evacuation hose 30 from collapsing onto itself when interconnected to the vacuum source 60. The preferred silicone material of the evacuation hose 30 provides a highly flexible yet lightweight and strong pneumatic and fluidic sealed interconnection between the evacuator tool connector 33 and vacuum connector 45. The lightweight character of the evacuation hose 30 in combination with high flexiblity reduces dentist hand fatigue and wrist fatigue during prolonged use. The material's resistance to heat and pressure enables it to be autoclaved for sterilization.

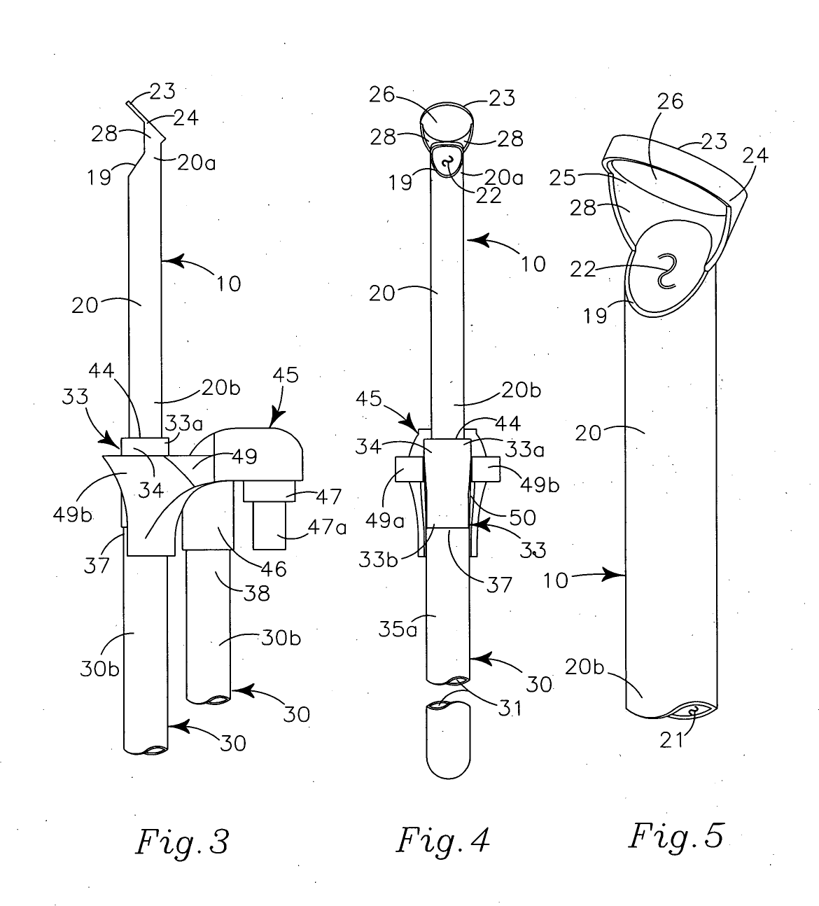

Vacuum connector 45 is carried at the second end portion 38 of the evacuation hose 30 providing a releasable operative interconnection with known vacuum source 60. As shown in FIG. 3, the vacuum connector 45 has a general inverted “U” shape and carries vertically downwardly extending hose connector portion 46 at a medial position and a similar vertically downwardly extending vacuum connector portion 47 at an end portion horizontally spaced apart from the hose connector portion 46. The hose connector portion 46 engages with and carries the second end portion 38 of the evacuation hose 30 so that the evacuation hose 30 depends therefrom in a fluid tight and pneumatic tight interconnection. A medial channel (not shown) is defined in the vacuum connector 45 extending through and communicating between the hose connector portion 46 and the vacuum connector portion 47. The vacuum connector portion 47 has a pipe-like male nozzle 47a configured for engagement with the known vacuum source 60. A seal (not shown), such as an O-ring, may be carried on the male nozzle 47a to promote a pneumatic tight and fluid tight interconnection between the vacuum connector portion 47 and the vacuum source 60.

Tool holder 49 is somewhat funnel shaped and is carried by the vacuum connector 45 spacedly adjacent the hose connector portion 46 and distal from the vacuum connector portion 47. The tool holder 49 has a first-half portion 49a and a horizontally spaced apart second half portion 49b with a vertical slot 50 therebetween. The vertical slot 50 provides a means for the evacuator tool connector 33 to be placed between the tool holder halves 49a, 49b so that the evacuator tool 10, the evacuator tool connector 33 and the first end portion 37 of the evacuation hose 30 are supported and maintained therebetween and at an easily accessible location for the dentist. The downwardly and inwardly tapering configuration of the tool holder 49 (FIG. 2, FIG. 4) prevents the evacuator tool connector 33 carrying the evacuator tool 10 and evacuation hose 30 from falling vertically therethrough.

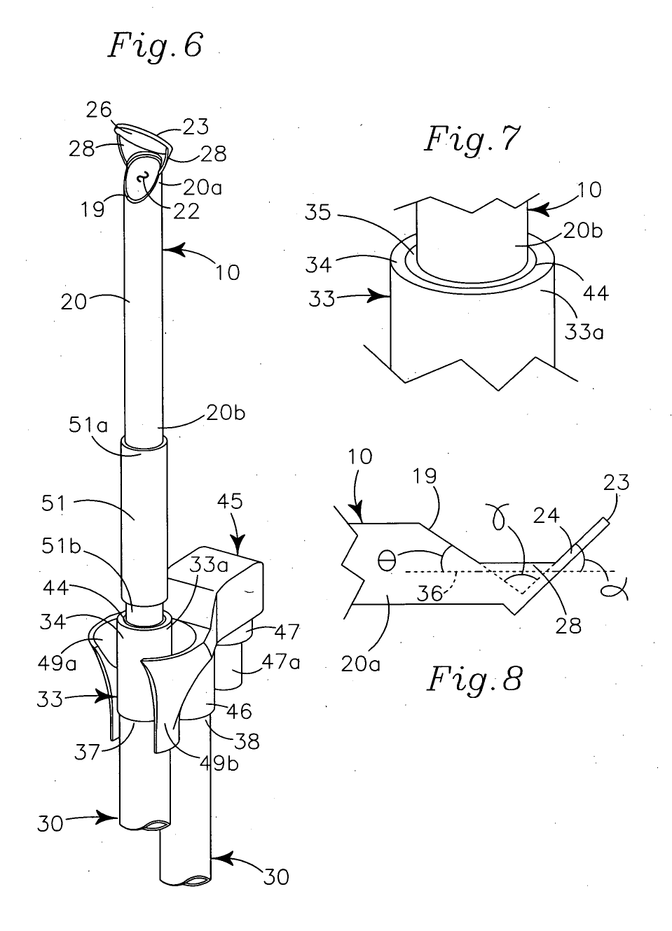

As shown in FIG. 6, if so desired by the dentist, an evacuator tool extension 51 may be inserted between the second end portion 20b of the evacuator tool 10 and the first end portion 33a of the evacuator tool connector 33 to increase the overall length and reach of the evacuator tool 10. The evacuator tool extension 51 has a first end portion 51a, an opposing second end portion 51b and defines a medial channel (not shown) extending therethrough and communicating therebetween. The second end portion 20b of the body 20 slidably engages in a male-female connection with the first end portion 51a of the extension 51, and the second end portion 51b of the extension 51, which is diametrically smaller than the first end portion 51a (FIG. 7), slidably engages with the inner pipe-like member 35 of the evacuator tool connector 33 to facilitate a fluid tight and pneumatic tight male-female connection therebetween.

Having described the structure of our ergonomic high volume evacuator system its operation may be understood.

The vacuum connector 45 is attached to a known vacuum source 60 by inserting the male nozzle portion 47a into a vacuum input orifice (not shown) of the vacuum source 60. If a seal (not shown) is carried on the male nozzle portion 47a, the seal should be inspected for wear and defects prior to engagement with the vacuum source 60. Second end portion 38 of the evacuation hose 30 is interconnected with the hose connector portion 46 of the vacuum connector 45 and depends therefrom. Evacuator tool connector 33 is carried at the first end portion 37 of the evacuation hose 30. In the preferred embodiment, the evacuator tool connector 33 and the vacuum connector 45 are not detachable from the evacuation hose 30.

The evacuator tool 10 is interconnected with the evacuator tool connector 33 by inserting the second end portion 20b of the body 20 into the medial channel (not shown) defined by the inner pipe-like member 35 of the axially rotatable interconnection 44 so that outer circumferential surface of the evacuator tool frictionally engages with inner circumferential surface of the medial channel of the inner pipe-like member 35.

While performing a dental procedure, the evacuator tool 10 is held by the dentist in one hand, similar to a writing instrument, preferably with the body 20 grasped between the dentist's thumb and forefinger so as to be easily manipulated. The evacuator tool 10 is manipulated by the dentist so that work surfaces, such as inner surfaces of teeth adjacent to the tongue can be visualized using the reflective insert 26 carried by the mirrored guard 23. The mirrored guard 23 may also be used to retract soft oral tissue away from a work surface and to protect tissue from dental instruments. Further, the mirrored guard 23 may be used as a “scoop” of sorts to collect dental debris from within a patient's mouth.

Vacuum supplied by the vacuum source 60 communicates through the evacuation hose 30 and draws dental debris liquid, solid and otherwise, into and through the input orifice 22 and into the medial channel 21 of the body 20. Thereafter the debris are drawn through the evacuator tool connector 33, the evacuation hose 30, the vacuum connector 45 and into the vacuum source 60 where the debris are collected through known means for sanitary disposal. There is no need to stop the procedure to evacuate the debris from the patient's mouth, nor is there a need for a second dental professional to continuously hold an evacuator tool while the dentist holds a mirror to visualize the dental instrument and the surface being worked upon.

When the dental procedure is complete the evacuator tool 10 is disconnected from the evacuator tool connector 33 by the user applying a simultaneous pulling, twisting and tilting force to the evacuator tool 10 while holding the evacuator tool connector 33 to minimize rotation. An antiseptic solution, or the like, may be drawn through the evacuation hose 30 to provide sterilization before another evacuator tool 10 is interconnected with the evacuator tool connector 33 and the system may be used again.

At the end of the day, or whenever appropriate, the entire ergonomic high volume evacuator system including the evacuation hose 30 with the attached evacuator tool connector 33 and the vacuum connector 45 may be autoclaved for sterilization in one piece. The evacuator tool 10 may also be autoclaved for sterilization but in the preferred embodiment the evacuator tool 10 is a single use disposable item.

The foregoing description of our invention is necessarily of a detailed nature so that a specific embodiment of a best mode may be set forth as is required, but it is to be understood that various modifications of details, and rearrangement, substitution and multiplication of parts may be resorted to without departing from its spirit, essence or scope.

Having thusly described our invention, what we desire to protect by Letters Patent, and

I claim:

1. An ergonomic system for a single dental professional to simultaneously evacuate dental debris from a patient's mouth, visualize a dental instrument and a surface being worked upon, the system pneumatically communicating with a dental vacuum source and autoclavable for sterilization, the system comprising in combination:
an evacuator tool having a tubular body with a first end portion, a spaced apart second end portion and defining a medial channel extending therebetween, the first end portion defining a beveled input orifice having a mirrored guard with an optically reflective insert proximate the input orifice and guard flanges interconnecting circumferential edge of the mirrored guard and circumferential edge portion of the input orifice;
a flexible evacuation hose carrying an evacuator tool connector at a first end portion, the evacuator tool connector providing an axial through channel communicating with medial channel defined by the evacuation hose and providing a releasable axially rotatable pneumatically sealed interconnection with the second end portion of the evacuator tool; and
a vacuum connector carried at second end portion of the evacuation hose communicating with the evacuation hose medial channel, the vacuum connector having a portion for releasable pneumatically sealed engagement with the vacuum source and a tool holder for releasably positionally maintaining the evacuator tool connector and interconnected first end portion of the evacuation hose.

2. The system of claim 1 wherein:
the mirrored guard defines a circular cavity in surface proximate to the input orifice and the optically reflective insert is positionally maintained within the circular cavity by overlapping inner circumferential edge portions of the circular cavity over outer circumferential edge portions of the optically reflective insert.

3. The system of claim 1 wherein:
the tool holder has a first half and a second half spaced apart by a vertical slot, the first half and second half having downwardly and inwardly tapering configurations to positionally retain the evacuator tool connector therebetween.

4. The system of claim 1 wherein:
the optically reflective insert is Mylar®.

5. The system of claim 1 wherein:
the optically reflective insert is polished steel.

6. The system of claim 1 wherein:
the optically reflective insert is a mirror.

7. The system of claim 1 wherein:
evacuator tool has an elongate axis and the bevel of the input orifice relative to the elongate axis is between 25 degrees and 50 degrees.

8. The system of claim 1 wherein:
evacuator tool has an elongate axis and the bevel of the input orifice relative to the elongate axis is 30 degrees.

9. The system of claim 1 wherein:
evacuator tool has an elongate axis and the angle of the mirrored guard relative to the elongate axis is between 25 degrees and 50 degrees.

10. The system of claim 1 wherein:
evacuator tool has an elongate axis and the angle of the mirrored guard relative to the elongate axis is 30 degrees.

11. The system of claim 1 wherein:
angle of the mirrored guard relative to the beveled input orifice is between 90 degrees and 130 degrees.

12. The system of claim 1 wherein:
angle of the mirrored guard relative to the beveled input orifice is 120 degrees.

13. The system of claim 1 wherein:
the evacuation hose is formed of silicone and has an internal coil spring to prevent collapsing under vacuum.
